(19) United States
(12) Patent Application Publication
(10) Pub. No.: US 2019/0264895 A1
(43) Pub. Date: Aug. 29, 2019

(54) System of Interconnecting Illumination Units

(71) Applicant: Faber A. Gutierrez, Newark, DE (US)

(72) Inventor: Faber A. Gutierrez, Newark, DE (US)

(21) Appl. No.: 16/285,183

(22) Filed: Feb. 25, 2019

Related U.S. Application Data
(60) Provisional application No. 62/634,457, filed on Feb. 23, 2018.

(51) Int. Cl. F21V 19/00; G09F 13/04; G09F 13/00; G09F 13/06; H05B 37/02

(52) U.S. Cl. CPC F21V 19/0085; G09F 13/0404; H05B 37/0272; G09F 13/06; G09F 13/005

(57) ABSTRACT

A system of interconnecting illumination units that are arranged to form an illuminating pattern, message, slogan, advertisement, etc. is provided. The system of interconnectable illumination units includes at least one interconnectable unit. The at least one interconnectable unit includes a unit body, at least one first channel, at least one second channel, and at least one light-generating device. The unit body may be any type of building material such as, but not limited to, a block, brick, or tile. The at least one first channel is an area within the unit body that receives and stores the at least one light-generating device. The at least one second channel is used to allow passage of light from the at least one light-generating device. The at least one light-generating device is main source of light energy which allows the system of interconnectable units to display an illuminating pattern, message, slogan, advertisement, etc.

The current application claims a priority to the U.S. Provisional Patent application Ser. No. 62/634,457 filed on Feb. 23, 2018. The current application is filed on Feb. 25, 2019 while Feb. 23, 2019 was on a weekend.

### FIELD OF THE INVENTION

The present invention relates generally to decorative panels. More specifically, the present invention is a system of interconnecting illumination units that are arranged to form an illuminating pattern, message, slogan, advertisement, etc.

### BACKGROUND OF THE INVENTION

Decorative surfaces and electric lighting are used in many applications for an aesthetic appeal. Applications using decorative surfaces or electric lighting have been used to display specific patterns, messages, slogans, advertisements, etc. Although this has been effective, there isn't an application which combines these two aspects in order to display specific patterns, messages, slogans, advertisements, etc.

It is therefore an objective of the present invention to provide a system of interconnecting illumination units that are arranged to form an illuminating pattern, message, slogan, advertisement, etc. The present invention combines the aspect of a decorative surface with electric lighting in order to form an aesthetically appealing display. The present invention can be used in many applications such as, but not limited, to household items, advertisements, interior aesthetics of a building, and exterior aesthetics of a building. Interior aesthetics and household accessories include, but are not limited to, doors, kitchen appliances, furniture, and other items which can be found in a common household. Further, exterior aesthetics include, but are not limited to, roofs, and mailboxes.

The present invention includes interconnectable units that can be connected to each other in order to display a specific illuminating pattern, message, slogan, advertisement, etc. Lights are integrated into each unit and the units include components or compositions which allow passage of the light. These components may also modify the light in order to display a specific illuminating pattern, message, slogan, advertisement, etc.

### BRIEF DESCRIPTION OF THE DRAWINGS

FIG. 1 is a front perspective view of the present invention displaying a plurality of second channels.

FIG. 2 is an exploded front perspective view of the present invention displaying the reflector.

FIG. 3 is a front perspective view of the present invention displaying two interconnectable units connected to each other.

FIG. 4 is a front perspective view of the present invention displaying a plurality of first channels.

FIG. 5 is an exploded front perspective view of the present invention displaying a plurality of first channels and a plurality of light-generating devices.

FIG. 6 is a front perspective view of the present invention displaying the embodiment with the base panel and the plurality of lights.

FIG. 7 is an exploded front perspective view of the present invention displaying the embodiment with the base panel and the plurality of lights.

FIG. 8 is a top perspective view of the present invention displaying the embodiment with the interchangeable optical modification panel.

FIG. 9 is an exploded top perspective view of the present invention displaying the embodiment with the interchangeable optical modification panel.

FIG. 10 is a schematic diagram displaying the interconnectable unit working in conjunction with the HVAC unit.

FIG. 11 is a schematic diagram displaying the electrical connection between the light-generating device and the solar panel.

FIG. 12 is a schematic diagram displaying the interconnectable unit integrated to the mailbox receptacle.

FIG. 13 is a schematic diagram displaying the interconnectable unit mounted to the wall surface by the fastener.

FIG. 14 is a schematic diagram displaying the electronic connections of the present invention.

FIG. 15 is a schematic diagram displaying the electrical connection between the light-generating device and the control box.

FIG. 16 is a schematic diagram displaying the interconnectable unit integrated to the telescopic sign.

### DETAIL DESCRIPTIONS OF THE INVENTION

All illustrations of the drawings are for the purpose of describing selected versions of the present invention and are not intended to limit the scope of the present invention.

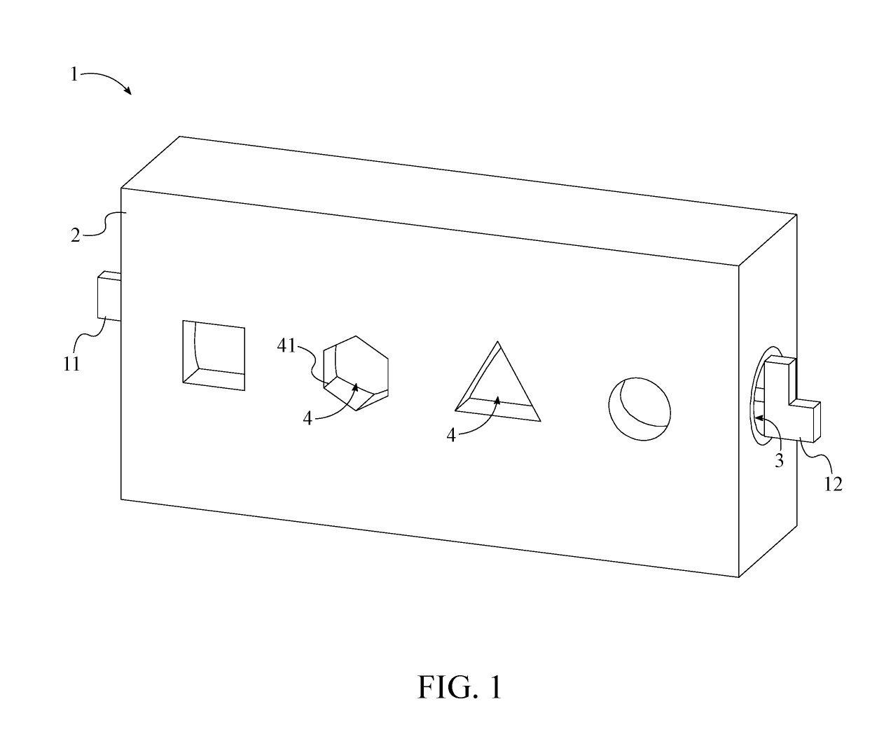

In reference to FIGS. 1 through 16, the present invention is a system of interconnecting illumination units that are arranged to form an illuminating pattern, message, slogan, advertisement, etc. In further detail, at least one interconnectable unit 1 is used to illuminate interior and exterior areas while also displaying an illuminating pattern, message. The at least one interconnectable unit 1 comprises a unit body 2, at least one first channel 3, at least one second channel 4, and at least one light-generating device 5. The unit body 2 is used to house the at least one light-generating device 5. The unit body 2 may be any type of building material such as, but not limited to, a block, brick, tile, and/or other similar building material. The unit body 2 may be composed of any material such as, but not limited to, crystal, glass, methacrylate, acrylic, recyclable plastic, phosphorescence, clay, mud, concrete, wood, rock, ceramic, rubber, PVC, or any other type of material which is used in construction. Moreover, the unit body 2 can be any size and/or any shape. Due to this, the present invention can be used in many applications including, but not limited to, household accessories, advertisements, interior aesthetics of a building, and exterior aesthetics of a building. The at least one first channel 3 is used to receive the at least one light-generating device 5. The at least one second channel 4 is used to allow passage of light produced by the at least one light-generating device 5. The at least one light-generating device 5 is used to produce light in order for the present invention to display an illuminating pattern, message, slogan, advertisement, etc.

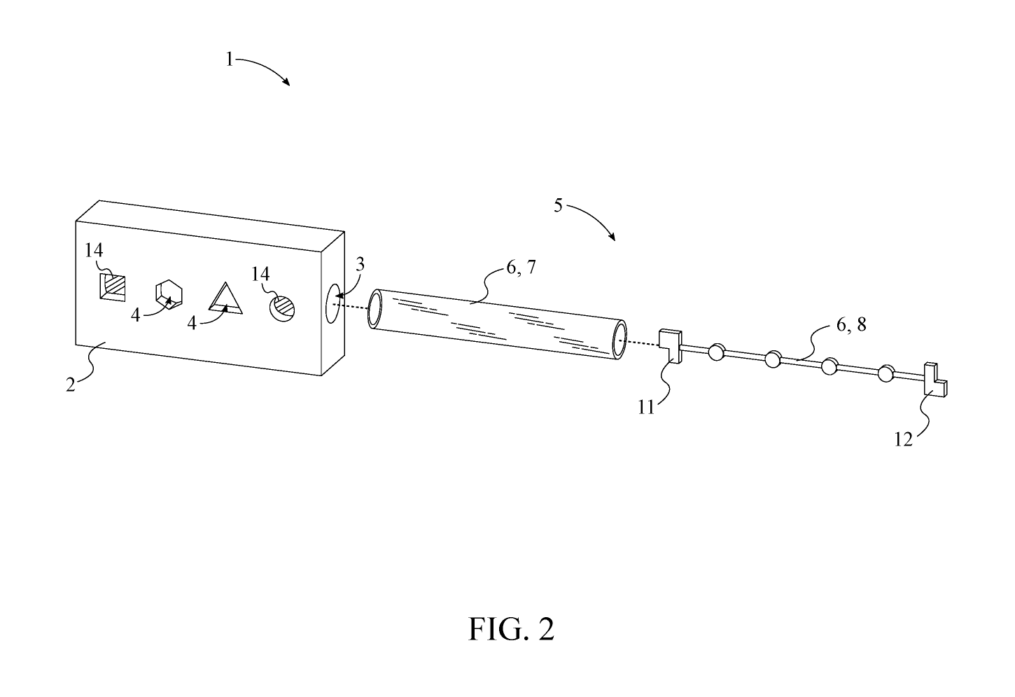

The general configuration of the aforementioned components allows the present invention to effectively and efficiently display an illuminating pattern, message, slogan, advertisement, etc. In reference to FIGS. 1 and 2, the at least one light-generating device 5 comprises an illumination body 6, a first connector 11, and a second connector 12. The illumination body 6 is the light-producing source of the at least one light-generating device 5. The first connector 11 and the second connector 12 are used to connect two or more interconnectable units together. The first connector 11 and the second connector 12 may be any type of device that can electrically and physically link two or more interconnectable units together. For example, the first connector 11 and the second connector 12 may be, but are not limited to, pressure-type, threaded, or magnet-type connectors. The at least one first channel 3 traverses through the unit body 2 in order to create an area to receive the at least one light-generating device 5. The at least one second channel 4 traverses into the unit body 2. Moreover, the at least one first channel 3 is laterally intersected by the at least one second channel 4. This arrangement allows passage of light from the at least one light-generating device 5, through the at least one first channel 3, and out the at least one second channel 4. The first connector 11 is connected adjacent to the illumination body 6. Similarly, the second connector 12 is connected adjacent to the illumination body 6, opposite to the first connector 11. This arrangement allows two or more interconnectable units to be connected to each other through the first connector 11 and the second connector 12. The illumination body 6 is mounted within the at least one first channel 3 in order for the at least one light-generating device 5 to maintained within the unit body 2. The first connector 11 and the second connector 12 are positioned external to the unit body 2 allowing two or more interconnectable units to be easily connected to each other.

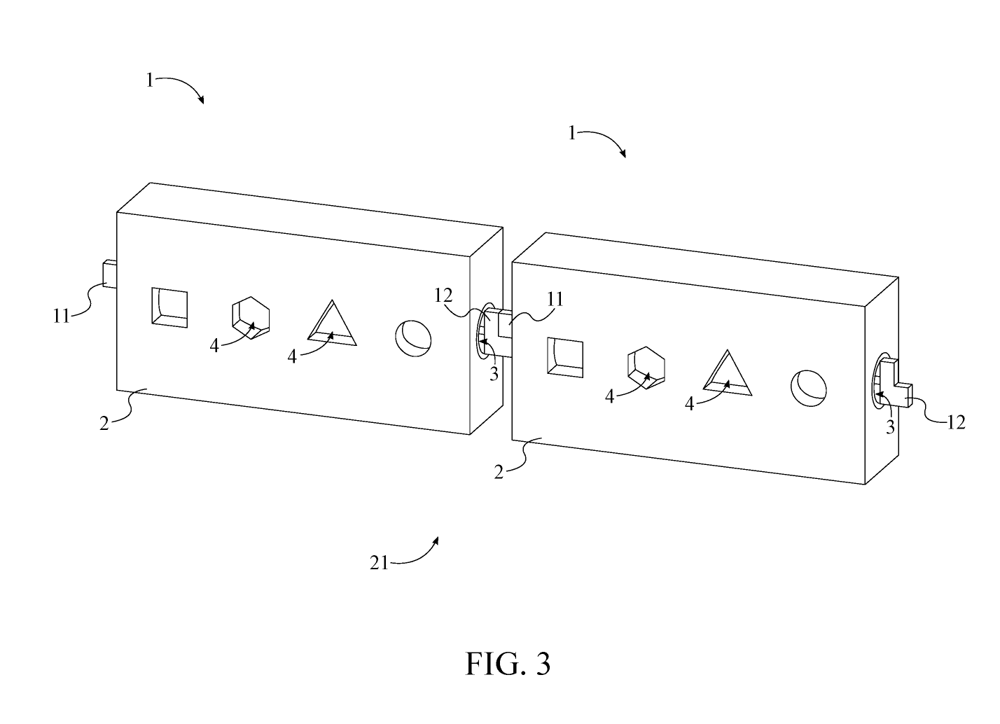

In order for the present invention to effectively display an illuminating pattern, message, slogan, advertisement, etc. and with reference to FIG. 3, the at least one interconnectable unit 1 is configured as a plurality of interconnectable units. Furthermore, to effectively display an illuminating pattern, message, slogan, advertisement, etc., the plurality of interconnectable units is arranged into a display configuration 21. In order to arrange the plurality of interconnectable units into a display configuration 21, the first connector 11 of an arbitrary unit is electrically and physically attached to the second connector 12 of an adjacent unit. The arbitrary unit and the adjacent unit are a pair of adjacent units from the plurality of interconnectable units. The electrical attachment between the arbitrary unit and the adjacent unit allow the illumination body 6 of the arbitrary unit and the illumination body 6 of the adjacent body to be synchronized to each other in order for the present invention to effectively display an illuminating pattern, message, slogan, advertisement, etc. The physical attachment between the arbitrary unit and the adjacent unit prevents the display configuration 21 from being separated.

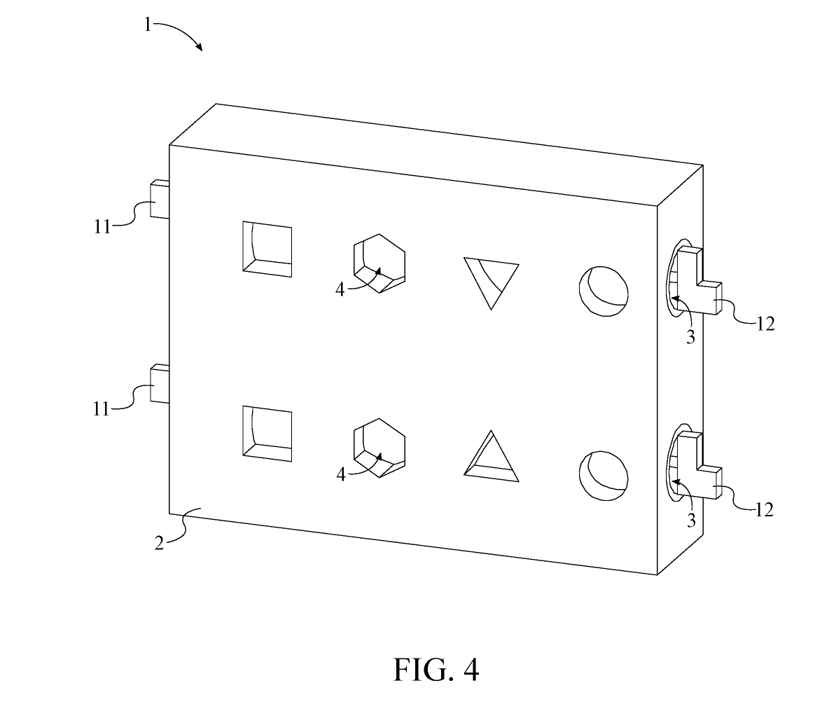

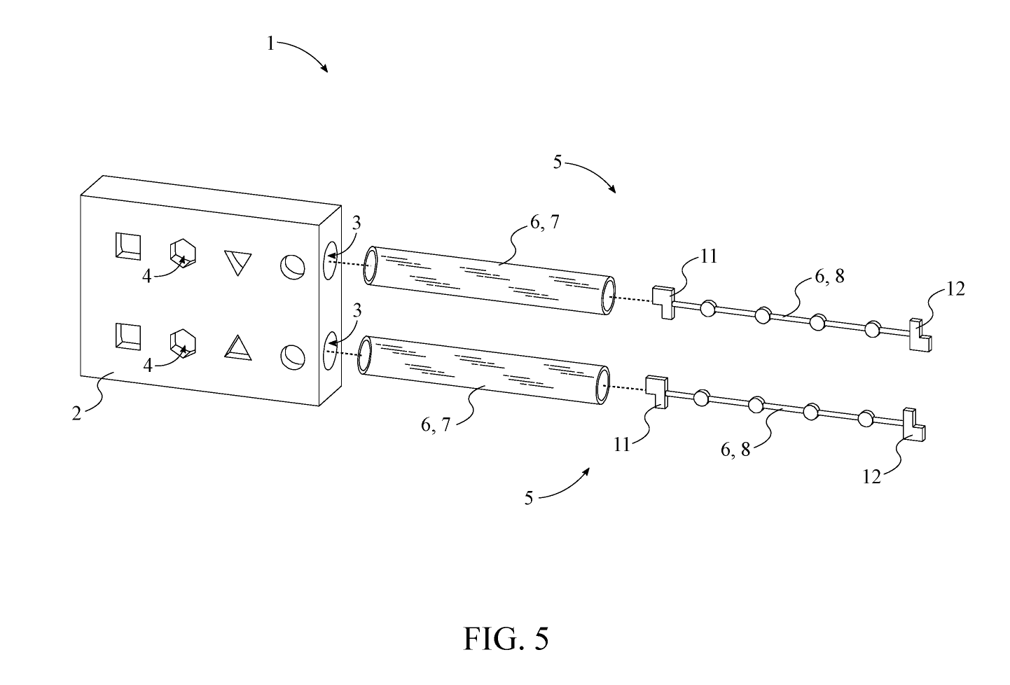

In order for the at least one interconnectable unit 1 to solely display an illuminating pattern, message, slogan, advertisement, etc. and with reference to FIGS. 4 and 5, the at least one first channel 3 is a plurality of first channels and the at least one light-generating device 5 is a plurality of light-generating devices. Preferably, the plurality of first channels is serially distributed across a face of the unit body 2 in order for the at least one interconnectable unit 1 to properly display an illuminating pattern, message, slogan, advertisement, etc. Moreover, the illumination body 6 of each of the plurality of light-generating devices is mounted within a corresponding channel from the plurality of first channels. This arrangement securely maintains the illumination body 6 of each of the plurality of light-generating devices within the corresponding channel from the plurality of first channels.

In a first embodiment of the present invention and with reference to FIGS. 1 and 2, the illumination body 6 comprises a transparent tubular housing 7 and a light strip 8. The transparent tubular housing 7 is used to prevent humidity inside the unit body 2 because humidity may impair the light produced by the at least one light-generating device 5. Additionally, the transparent tubular housing 7 is used to support and add resistance to the unit body 2. In further detail, the tubular housing 7 protects the unit body 1 from impacts and shocks. The light strip 8 is the light-producing source of the light-generating device. Preferably, the light strip 8 includes a series of LED lights, but the light strip 8 may include a series of any type of lights such as, but not limited to, electroluminescent or solar lights. In order for the transparent tubular housing 7 to effectively prevent humidity inside the unit body 2 and to support the at least one light-generating device 5, the transparent tubular housing 7 is mounted within the at least one first channel 3. In order for the to be supported by the transparent tubular housing 7, the light strip 8 is mounted through and along the transparent tubular housing 7. The first connector 11 and the second connector 12 are electrically connected to the light strip 8 in order to allow connection of the light strip 8 of an adjacent interconnectable unit. Furthermore, in this embodiment, the at least one second channel 4 is a plurality of perforations which allows passage of light produced from the light strip 8 and therefore allows the present invention to display an illuminating pattern, message, slogan, advertisement, etc.

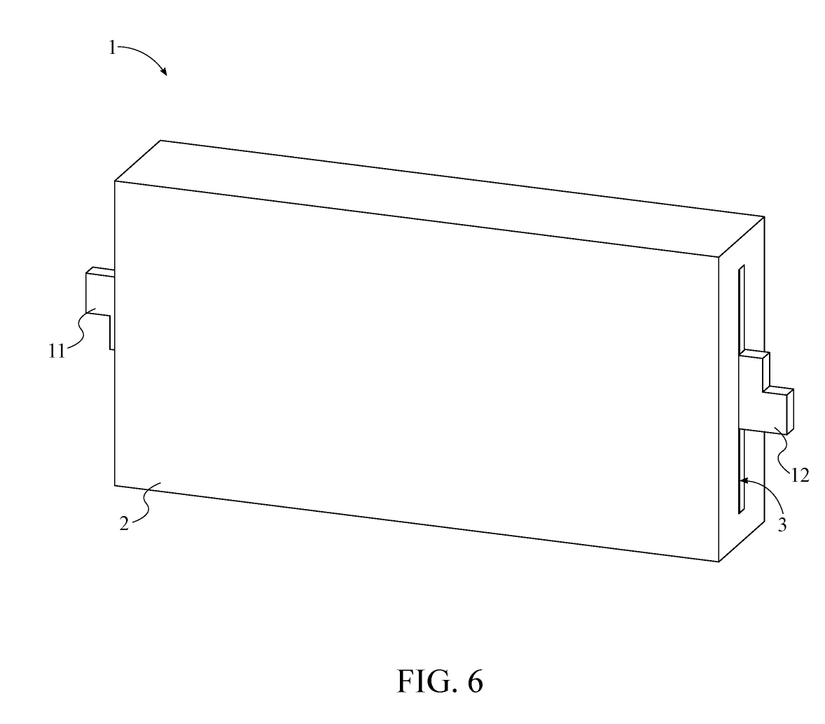

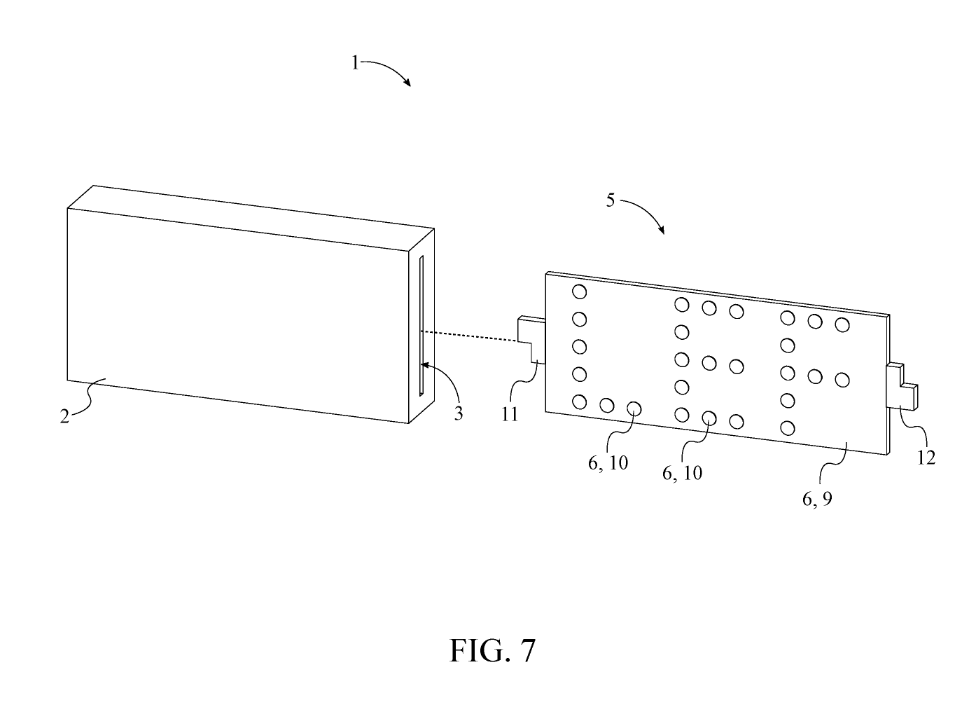

In a second embodiment of the present invention and with reference to FIGS. 6 and 7, the illumination body 6 comprises a base panel 9 and a plurality of lights 10. The base panel 9 is a piece of material that can be attached to the unit body 2 and is used to contain the plurality of lights 10. Preferably, the plurality of lights 10 is LED lights, but the plurality of lights 10 may be any other type of light such as, but is not limited to, an electroluminescent or solar light. The base panel 9 is mounted within the at least one first channel 3. In this embodiment, the at least one first channel 3 is a slot that is shaped and sized to properly receive the base panel 9. This arrangement properly secures the base panel 9 to the unit body 2. Moreover, this arrangement allows a user to easily remove the base panel 9 from the at least one first channel 3 to provide maintenance to the base panel 9 or to replace the base panel 9. The plurality of lights 10 is mounted across the base panel 9 and is arranged in a symbolic configuration. This arrangement properly secures and positions the plurality of lights 10 in order for the present invention to display an illuminated pattern, message, slogan, advertisement, etc. through the base panel 9. In order to allow connection of the plurality of lights 10 of an adjacent interconnectable unit, the first connector 11 and the second connector 12 are electrically connected to the plurality of lights 10.

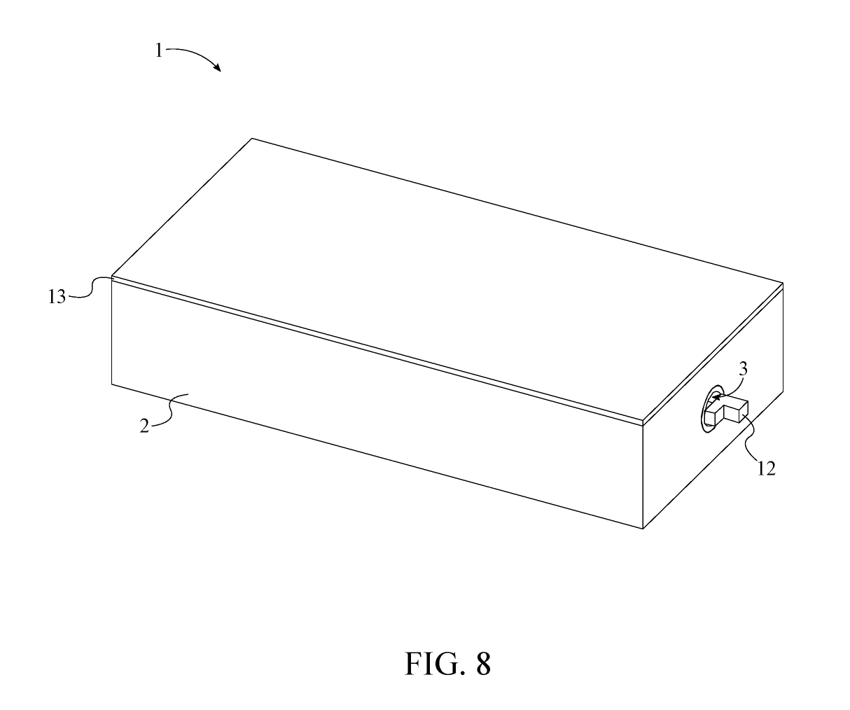

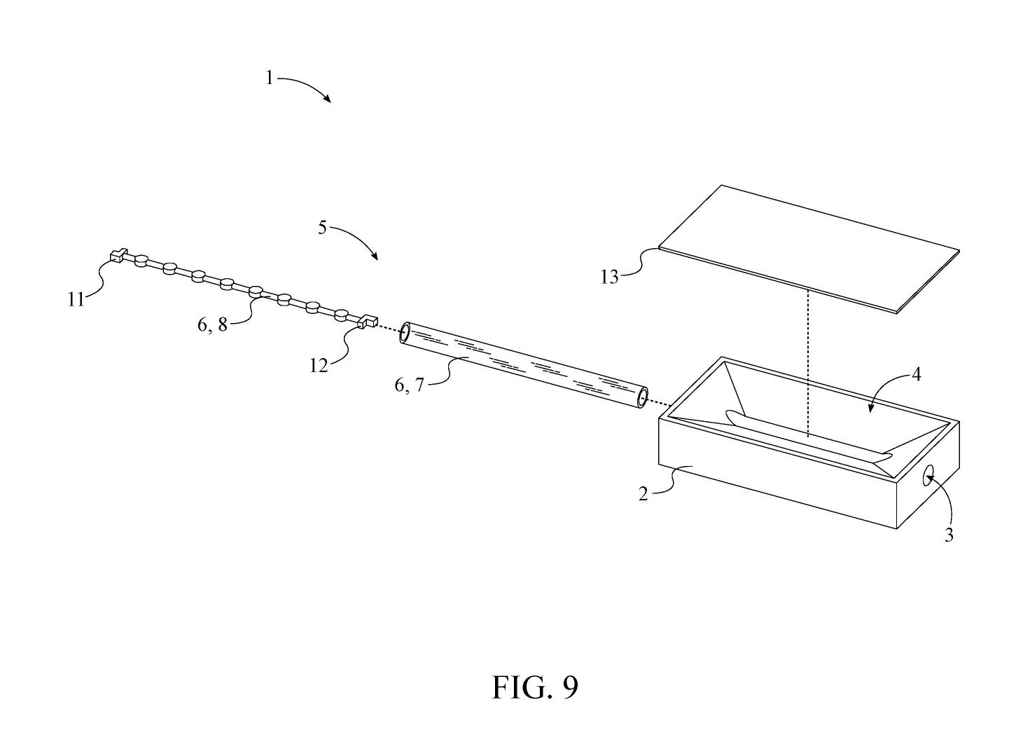

In a third embodiment of the present invention and with reference to FIGS. 8 and 9, the at least one interconnectable unit 1 may further comprise an interchangeable optical modification panel 13. The interchangeable optical modification panel 13 is used to modify the light produced by the at least one light-generating device 5 in order to display an illuminating pattern, message, slogan, advertisement, etc. The interchangeable optical modification panel 13 is mounted within the at least one second channel 4 and is positioned parallel to the at least one first channel 3. The at least one second channel 4 is a cutout that is shaped and sized to receive the interchangeable optical modification panel 13. This arrangement properly secures and positions the interchangeable optical modification panel 13 to the unit body 2. The unit body 2 of the third embodiment may be referred to as a “frog-style” unit body 2 due to the design of the unit body 2 with reference to at least one second channel 4.

If the unit body 2 is not composed of transparent material and with reference to FIG. 2, the at least one interconnectable unit 1 may further comprise at least one reflector 14. The at least one reflector 14 is used to reflect the light produced by the at least one light-generating device 5 through the at least one second channel 4. The at least one reflector 14 may be made of any reflecting material such as, but not limited to, silicone resin, acrylic, crystal, or a magnifying glass. In order for the at least one reflector 14 to properly reflect light produced by the at least one light-generating device 5, the at least one reflector 14 is optically integrated within the at least one second channel 4.

If the unit body 2 is not composed of transparent material and in order for the present invention to display an illuminated pattern, message, slogan, advertisement, etc. and with reference to FIG. 1, the at least one second channel 4 is a plurality of second channels. A transversal cross-section 41 for each of the plurality of second channels is delineated by an easily-distinguishable perforation shape. In further detail, light shines from the at least one light-generating device 5 through the transversal cross-section 41 for each of the plurality of second channels in order for the present invention to display an illuminated pattern, message, slogan, advertisement, etc.

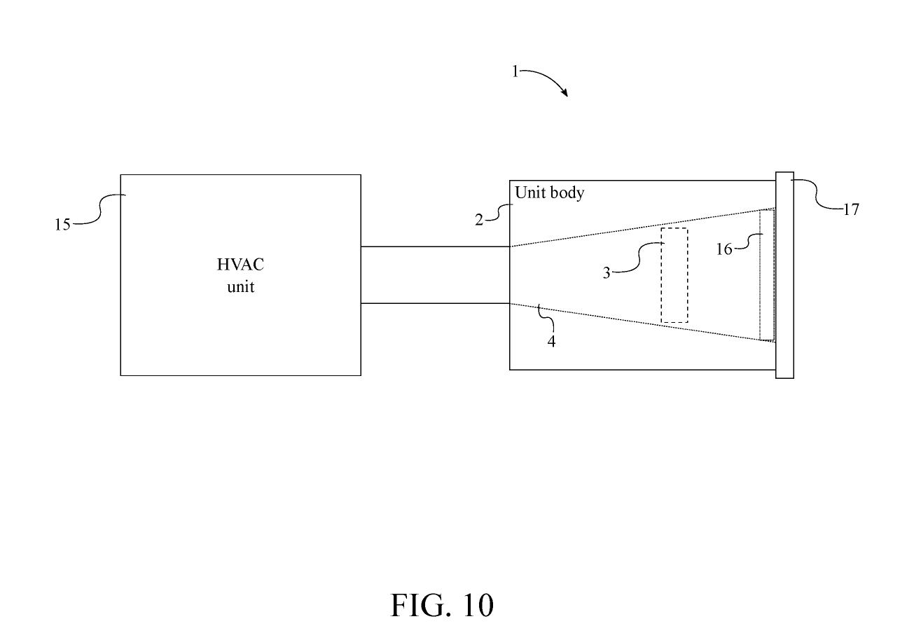

With reference to FIG. 10, the present invention may further comprise a heating, ventilation, and air-conditioning (HVAC) unit 15. The HVAC unit 15 allows the present invention to be applied to the exhaust and/or vents inside buildings such as, but not limited to, family homes or apartment complexes. The at least one second channel 4 further traverses out of the unit body 2 and the HVAC unit 15 is in fluid communication the at least one second channel 4 in order to allow heating or air-conditioning to pass through the unit body 2. In further detail, the at least one second channel 4 is a vent in this embodiment. Moreover, the at least one interconnectable unit 1 may further comprise at least one air filter 16 and at least one ventilated cover 17. The at least one air filter 16 is used to filter the air passing through the unit body 2 making it safe for users to breathe in the air. The at least one ventilated cover 17 is used to allow air to flow from the HVAC unit 15 and into a room of a building. The at least one air filter 16 is mounted within the at least one second channel 4 and is positioned parallel to the at least one first channel 3. This properly secures and positions the at least one air filter 16 for the present invention to provide heating or air-conditioning that is safe to breathe. The at least one ventilated cover 17 is mounted into the at least second channel and is positioned external to the unit body 2. Preferably, the at least one ventilated cover 17 is mounted into the at least one second channel 4 by use of a threaded fastener. This arrangement properly secures and positions the at least one ventilated cover 17 in order to allow air to freely flow from the HVAC unit 15 and into a room. Furthermore, the at least one ventilated cover 17 allows passage of light produced by the at least one light-generating device 5.

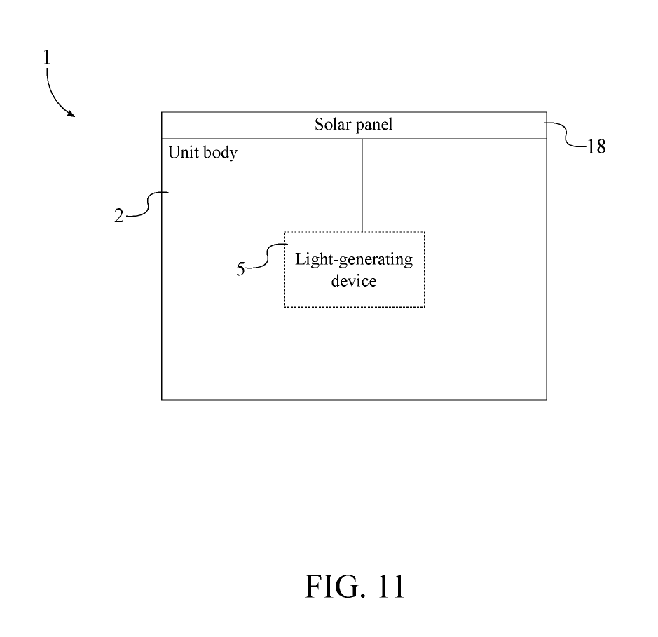

With reference to FIG. 11, the present invention may further comprise at least one solar panel 18. The at least one solar panel 18 may be used as a power source for the present invention and to generally generate electricity for a building. The at least one solar panel 18 is mounted external to the unit body 2 in order for the at least one solar panel 18 to properly harness sunlight energy. Moreover, the at least one solar panel 18 is electrically connected to the at least one light-generating device 5 in order for the at least one solar panel 18 to be the power source of the present invention.

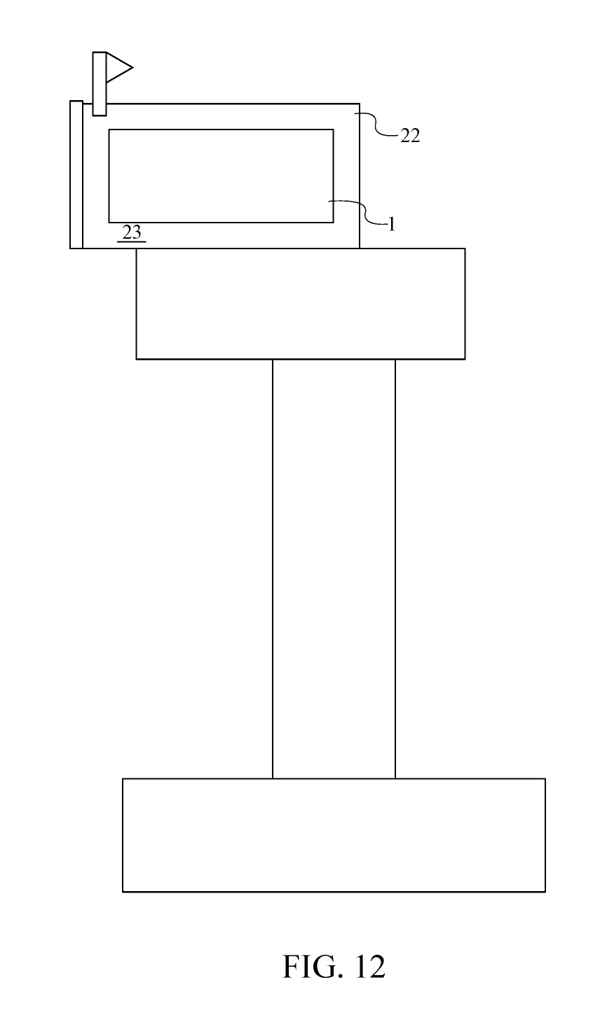

With reference to FIG. 12, the present invention may further comprise a mailbox receptacle 22. The mailbox receptacle 22 is used to receive paper mail. The present invention can be applied to the mailbox receptacle 22 in order for the mailbox receptacle 22 to display an illuminating pattern, message, slogan, advertisement, etc. The at least one interconnectable unit 1 is integrated into a lateral wall 23 of the mailbox receptacle 22 in order for the mailbox receptacle 22 to display an illuminating pattern message. In further detail, the at least one interconnectable unit 1 may be used to display a series of alphanumeric characters which can be, but is not limited to, a family name, a landscape name, or an advertisement. Additionally, this embodiment may use any technique such as, but not limited to, the at least one second channel 4 being perforations, using the interchangeable optical modification panel, using the “frog-style” unit body, retro illumination, and electroluminescence. Also, the first connector 11 and the second connector 12 may be threaded-type connectors. Moreover, the present invention includes a vertical post and a base. The vertical post is connected to the base and the mailbox receptacle 22 is mounted to the vertical post. Similar to the mailbox receptacle 22, the at least one interconnectable unit 1 is integrated into a lateral wall 23 of the vertical post in order for the vertical post to display an illuminated pattern, message, slogan, advertisement, etc. In further detail, the at least one interconnectable unit 1 may be used to display a series of alphanumeric characters which can be, but is not limited to, the address number of a household. Furthermore, the unit body 2 of the vertical post is preferably a “frog-style” unit body 2 which can receive the interchangeable optical modification panel 13. The at least one second channel 4 tapers towards the at least one first channel 3 in the “frog-style” unit body 2 in order for light, produced by the at least one light-generating device 5, to be reflected about the unit body 2. For a masonry-style mailbox receptacle 22 where the mailbox receptacle is enclosed by building material, the at least one interconnectable unit 1 is connected laterally to the mailbox receptacle 22 and distributed around the mailbox receptacle 22.

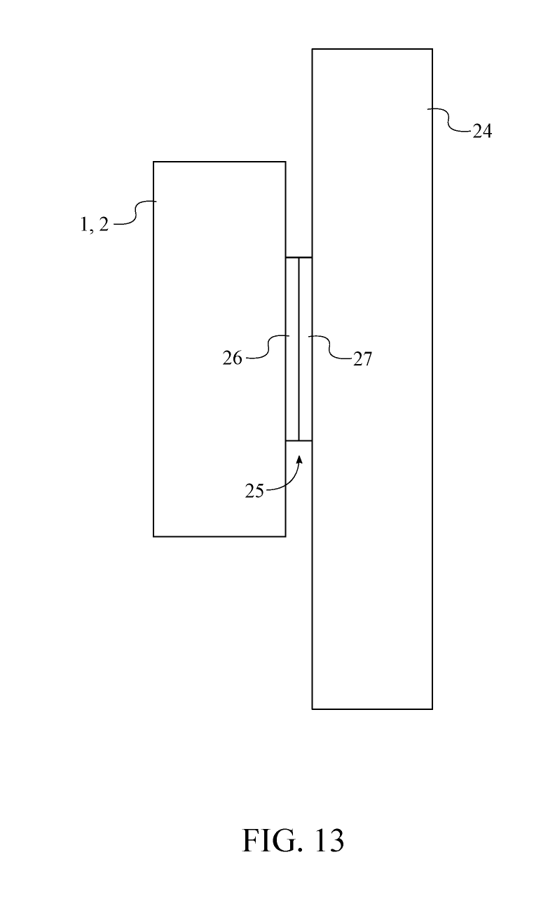

With reference to FIG. 13, the present invention may further comprise a wall surface 24 and a fastener 25. The wall surface 24 may be any wall surface area inside a building. The present invention can be applied to the wall surface 24 in order for the wall surface 24 to display an illuminating pattern, message, slogan, advertisement, etc. The fastener 25 is preferably a magnetic fastener, but the fastener 25 may be any type of attaching means. The at least one interconnectable unit 1 is mounted into the wall surface 24 by the fastener 25 in order to properly secure the at least one interconnectable unit 1 to the wall surface 24. Moreover, this arrangement allows a user to easily remove the at least one interconnectable unit 1 in order to provide maintenance or to replace the at least one interconnectable unit 1 if defective. The fastener 25 comprises a first interlocking portion 26 and a second interlocking portion 27. The first interlocking portion 26 is mounted external to the unit body 2 and positioned opposite to the at least one second channel 4 about the unit body 2. This arrangement properly positions the first interlocking portion 26 to the unit body 2 in order for the fastener 25 to be used to mount the at least one interconnectable unit 1 to the wall surface 24. The second interlocking portion 27 is mounted onto the wall surface 24. This arrangement properly positions the second interlocking portion 27 in order for the wall surface 24 to receive the at least one interconnectable unit 1 using the fastener 25. Furthermore, this allows a user to easily remove the at least one interconnectable unit 1 from the wall surface 24 in cases where the at least one light-generating device 5 is faulty or the at least one interconnectable unit 1 has been vandalized. In this wall surface 24 embodiment, the unit body 2 is preferably composed of acrylic or concrete material.

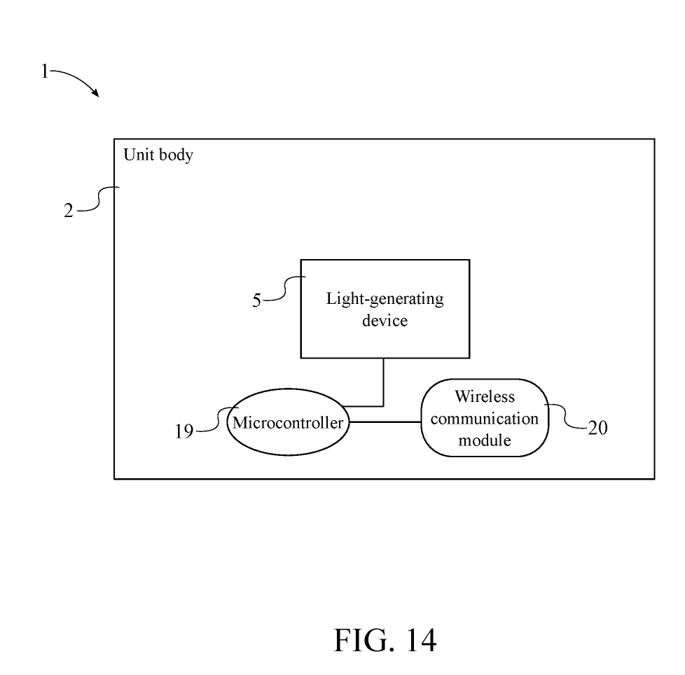

With reference to FIG. 14, the at least one interconnectable unit 1 may further comprise a microcontroller 19 and a wireless communication module 20. The microcontroller 19 is used to manage the functions of the at least one light-generating device 5 and the wireless communication module 20. The wireless communication module 20 allows a user to remotely control the present invention by using a computing device such as, but not limited to, a mobile device, smartphone, electronic tablet, laptop, or a remote control. The microcontroller 19 and the wireless communication module 20 are mounted within the unit body 2 in order to protect and conceal the microcontroller 19 and the wireless communication module 20. Furthermore, the at least one light-generating device 5 and the wireless communication module 20 are electrically connected to the microcontroller 19 in order for the microcontroller 19 to properly manage the functions of the at least one light-generating device 5 and the wireless communication module 20.

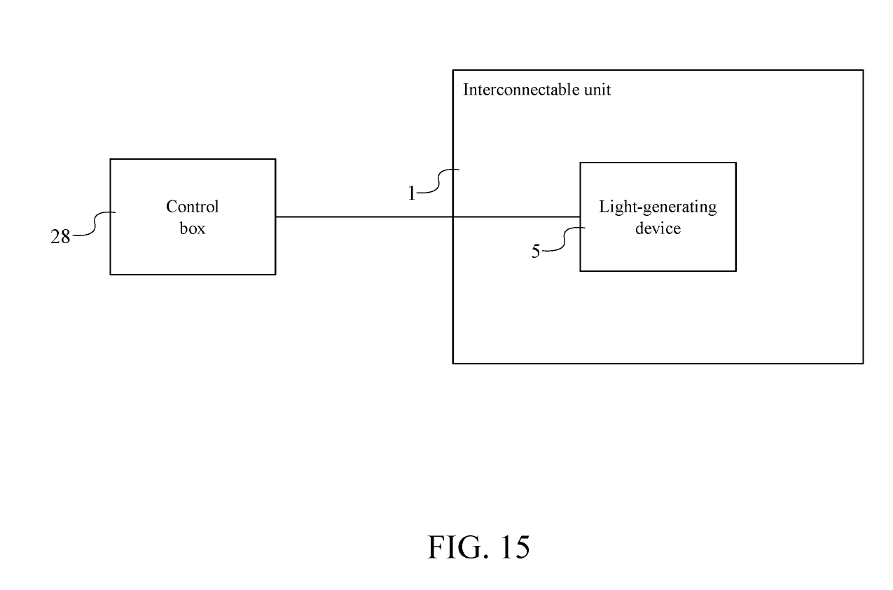

With reference to FIG. 15, the present invention may further comprise a control box 28. The control box 28 is used to manage the functions of the at least one light-generating device 5. The control box 28 may include control buttons which allow the user to manage the functions of the at least one light-generating device 5 such as, but not limited to, a power button, a speed-control button, a pattern-control button, or other similar control buttons which are commonly used for light-generating devices. The control box 28 is positioned offset from the at least one interconnectable unit 1 in order for a user to safely control the present invention through the control box 28. Moreover, the control box 28 is electrically connected to the at least one light-generating device 5 in order for the control box 28 to properly manage the functions of the at least one light-generating device 5.

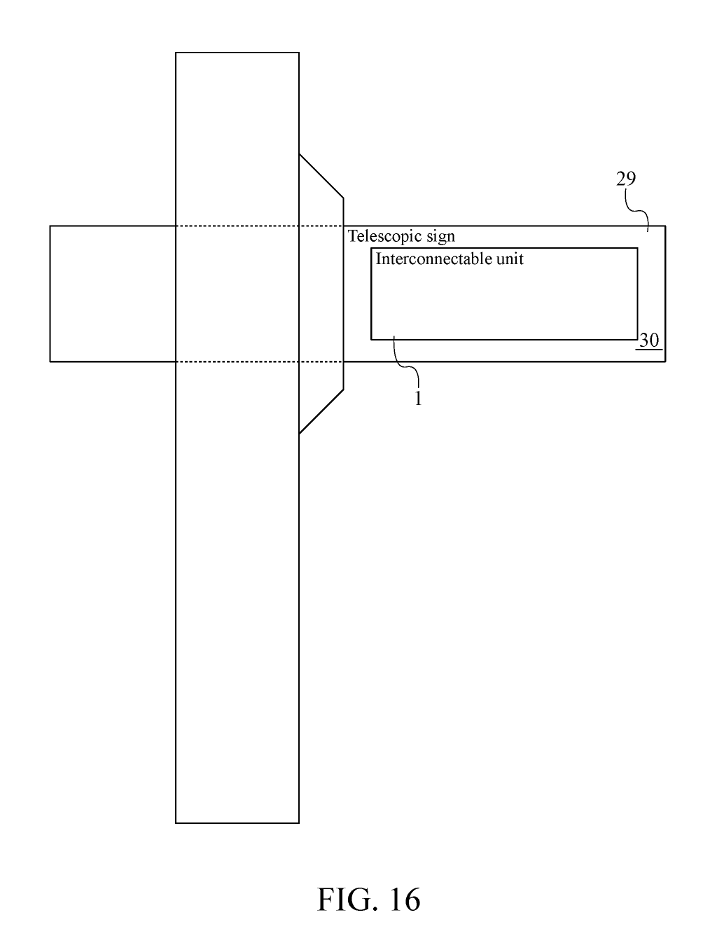

With reference to FIG. 16, the present invention may further comprise a telescopic sign 29. The telescopic sign 29 is used to display messages such as, but not limited to, advertisements, logos, or slogans. The present invention can be applied to the telescopic sign 29 in order for the telescopic sign 29 to display an illuminating pattern, message, slogan, advertisement, etc. The at least one interconnectable unit 1 is integrated to a display face 30 of the telescopic sign 29. This arrangement properly positions the at least one interconnectable unit 1 onto the telescopic sign 29 in order for telescopic sign 29 to display an illuminated pattern, message, slogan, advertisement, etc. The present invention may further comprise a second wall surface and a sign mount. A cavity of the second wall surface is receive the telescopic sign 29. The sign mount is mounted into the cavity of the second wall surface. The sign mount is used to telescopically mount the telescopic sign 29 to the cavity of the second wall surface. The sign mount is preferably a ring-shaped mount which includes a plurality of tension devices. The plurality of tension devices is radially distributed and connected laterally to the sign mount. The plurality of tension devices is used to support the telescopic sign 29 and prevents any water from damaging the present invention. The telescopic sign 29 may be retracted into the second wall surface when not in use or pulled out of the second wall surface through the sign mount. The wiring and the control box 28 is concealed behind the second wall surface for aesthetic purposes.

In embodiments where the unit body 2 is composed of transparent material such as, but not limited to, glass, acrylic, or methacrylate, the present invention does not require the at least one second channel 4. The light, produced by the at least one light-generating device 5, can pass through the unit body 2 with this composition. Therefore, there is no need for the at least one second channel 4 to allow passage of light for the present invention. This type of embodiment may be integrated to outdoor objects such as, but not limited to, street light posts or utility poles.

In another embodiment of the present invention, the unit body 2 may be composed of glass material and the at least one interconnectable unit may further comprise a frame. The frame is connected around the unit body 2 and composed of recyclable plastic. The frame is used to add rigidity to the present invention because the unit body 2 is composed of sensitive material. The frame is used to enclose the first connector 11 and the second connector 12. This embodiment allows light to pass through the unit body 2 and provides a rigid structure through the frame in order to connect two or more interconnectable units together.

In another embodiment of the present invention, an individual interconnectable unit may be engraved with alphanumeric characters such as, but not limited to, a family name. The individual interconnectable unit may be engraved using various methods including, but not limited to, a laser-engraving machine. Furthermore, the at least one light-generating device 5 of the individual interconnectable unit is preferably powered by replaceable or rechargeable batteries.

The following steps are to change a defective interconnectable unit which is formed on a permanent wall, mural, façade, or other surface where the present invention is integrated. The first step is to withdraw the filling of concrete, silicone, or other material at the perimeter of the defective interconnectable unit. The second step is to cut the first connector 11 and the second connector 12 at the border of the defective interconnectable unit to change the defective interconnectable unit. The third step is to withdraw or clean the tape and the silicone which are the sides of the defective interconnectable unit. The fourth step is to install and position a new interconnectable unit, a new first connector 11, a new second connector 12 and to inject at all sides with silicone and tape. The last step is to refill all the empty spaces.

In another embodiment of the present invention where the unit body 2 is a tile building material. The at least one second channel 4 is preferably engraved into the unit body 2 through a laser-engraving machine. Furthermore, the at least one light-generating device 5 is shaped, sized, and designed the same as the at least one second channel 4 in order for light to efficiently pass through the at least one second channel 4. The at least one interconnectable unit may further comprise a protective mesh and a border. The protective mesh is mounted within the at least one second channel 4 and the border is connected around the unit body 2. This embodiment preferably uses pressure-type or magnet-type connectors as the first connector 11 and the second connector 12.

Although the invention has been explained in relation to its preferred embodiment, it is to be understood that many other possible modifications and variations can be made without departing from the spirit and scope of the invention as hereinafter claimed.

What is claimed is:

1. A system of interconnecting illumination units comprises:
at least one interconnectable unit;
the at least one interconnectable unit comprises a unit body, at least one first channel, at least one second channel, and at least one light-generating device;
the at least one light-generating device comprises an illumination body, a first connector, and a second connector;
the at least one first channel traversing through the unit body;
the at least one second channel traversing into the unit body;
the at least one first channel being laterally intersected by the second channel;
the first connector being connected adjacent to the illumination body;
the second connector being connected adjacent to the illumination body, opposite to the first connector; and
the illumination body being mounted within the at least one first channel;
the first connector and the second connector being positioned external to the unit body.

2. The system of interconnecting illumination units as claimed in claim 1 comprises:
the at least one interconnectable unit being a plurality of interconnectable units;
the plurality of interconnectable units being arranged into a display configuration; and
the first connector of an arbitrary unit being electrically and physically attached to the second connector of an adjacent unit, wherein the arbitrary unit and the adjacent unit are a pair of adjacent units from the plurality of interconnectable units.

3. The system of interconnecting illumination units as claimed in claim 1 comprises:
the at least one first channel being a plurality of first channels;
the at least one light-generating device being a plurality of light-generating device;
the plurality of first channels being serially distributed across a face of the unit body; and
the illumination body of each of the plurality of light-generating devices being mounted within a corresponding channel from the plurality of first channels.

4. The system of interconnecting illumination units as claimed in claim 1 comprises:
the illumination body comprises a transparent tubular housing and a light strip;
the transparent tubular housing being mounted within the at least one first channel;
the light strip being mounted through and along the transparent tubular housing; and
the first connector and the second connector being electrically connected to the light strip.

5. The system of interconnecting illumination units as claimed in claim 1 comprises:
the illumination body comprises a base panel and a plurality of lights;
the base panel being mounted within the at least one first channel;
the plurality of lights being mounted across the base panel;
the plurality of lights being arranged in a symbolic configuration; and
the first connector and the second connector being electrically connected to the plurality of lights.

6. The system of interconnecting illumination units as claimed in claim 1 comprises:
the at least one interconnectable unit comprises an interchangeable optical modification panel;
the interchangeable optical modification panel being mounted within the at least one second channel; and
the interchangeable optical modification panel being positioned parallel to the at least one first channel.

7. The system of interconnecting illumination units as claimed in claim 1 comprises:
the at least one interconnectable unit comprises at least one reflector; and
the at least one reflector being optically integrated within the at least one second channel.

8. The system of interconnecting illumination units as claimed in claim 1 comprises:
the at least one second channel being a plurality of second channels; and
a transversal cross-section for each of the plurality of second channels being delineated by an easily-distinguishable perforation shape.

9. The system of interconnecting illumination units as claimed in claim 1 comprises:
a heating, ventilation, and air-conditioning (HVAC) unit;
the at least one second channel further traversing out of the unit body; and
the HVAC unit being in fluid communication with the at least one second channel.

10. The system of interconnecting illumination units as claimed in claim 9 comprises:
the at least one interconnectable unit comprises at least one air filter and at least one ventilated cover;
the at least one air filter being mounted within the at least one second channel;
the at least one air filter being positioned parallel to the at least one first channel;
the at least one ventilated cover being mounted into the at least one second channel; and
the at least one ventilated cover being positioned external to the unit body.

11. The system of interconnecting illumination units as claimed in claim 1 comprises:
the at least one interconnectable unit comprises at least one solar panel;
the at least one solar panel being mounted external the unit body; and
the at least one solar panel being electrically connected to the at least one light-generating device.

12. The system of interconnecting illumination units as claimed in claim 1 comprises:
a mailbox receptacle; and
the at least one interconnectable unit being integrated into a lateral wall of the mailbox receptacle.

13. The system of interconnecting illumination units as claimed in claim 1 comprises:
a wall surface;
a fastener; and
the at least one interconnectable unit being mounted into the wall surface by the fastener.

14. The system of interconnecting illumination units as claimed in claim 13 comprises:
the fastener comprises a first interlocking portion and a second interlocking portion;
the first interlocking portion being mounted external to the unit body;
the first interlocking portion being positioned opposite to the at least one second channel about the unit body; and
the second interlocking portion being mounted onto the wall surface.

15. The system of interconnecting illumination units as claimed in claim 1 comprises:
the at least one interconnectable unit comprises a microcontroller and a wireless communication module;
the microcontroller and the wireless communication module being mounted within the unit body; and
the at least one light-generating device and the wireless communication module being electronically connected to the microcontroller.

16. The system of interconnecting illumination units as claimed in claim 1 comprises:
a control box;
the control box being positioned offset from the at least one interconnectable unit; and
the control box being electrically connected to the at least one light-generating device.

17. The system of interconnecting illumination units as claimed in claim 1 comprises:
a telescopic sign; and
the at least one interconnectable unit being integrated to a display face of the telescopic sign.
